(19) United States
(12) Patent Application Publication
(10) Pub. No.: US 2020/0364661 A1
(43) Pub. Date: Nov. 19, 2020

(54) BATTERY INFORMATION MANAGEMENT SYSTEM AND BATTERY INFORMATION MANAGEMENT METHOD

(71) Applicant: TOYOTA JIDOSHA KABUSHIKI KAISHA, Toyota-shi (JP)

(72) Inventor: Hiroshi YAMASAKI, Nagoya-shi (JP)

(21) Appl. No.: 16/840,630

(22) Filed: Apr. 6, 2020

(30) Foreign Application Priority Data
May 14, 2019 (JP) 2019-091494

(51) Int. Cl. G06Q 10/08; G06Q 10/00; G06Q 30/02; B60L 53/66; B60L 53/80; B60L 58/12

(52) U.S. Cl. CPC G06Q 10/0875; G06Q 10/20; B60L 58/12; B60L 53/66; B60L 53/80; G06Q 30/0284

(57) ABSTRACT

A server uses a travel history of an electric-powered vehicle to estimate the deterioration state of a battery, and stores the estimated deterioration state in association with information for identifying the electric-powered vehicle. When a transmission request for deterioration information is executed at a user terminal, the server transmits the deterioration information to the user terminal. When a shop terminal receives information on a replacement condition for the battery from the user terminal, the shop terminal transmits, to the user terminal, inventory information corresponding to a replacement battery that satisfies the replacement condition.

This nonprovisional application is based on Japanese Patent Application No. 2019-091494 filed on May 14, 2019 with the Japan Patent Office, the entire contents of which are hereby incorporated by reference.

### BACKGROUND

### Field

The present disclosure relates to information management for a battery mounted on an electric-powered vehicle.

### Description of the Background Art

Japanese Patent No. 5249079 discloses a technique of a payment process for a removable battery for electric-powered vehicle. In this technique, an IC chip updatably stores battery information, such as the number of times the battery can be charged, the number of days the battery was used, the usable period of time, or the quantity of remaining electricity. For example, when the battery is replaced, the difference in deterioration state between before and after the replacement is estimated based on the battery information. Then, in accordance with the estimated difference, the payment process is performed.

### SUMMARY

However, even with the same duration of use, the deterioration state of a battery can greatly vary depending on the use history of the electric-powered vehicle. Thus, in some cases, the deterioration state of a battery cannot be accurately estimated from the above-described battery information. If, for example, the user cannot accurately know the deterioration state of the battery on his vehicle, at the time of battery replacement, he may select a replacement battery that is more deteriorated than before the replacement.

An object of the present disclosure is to provide a battery information management system and a battery information management method that allow the user to appropriately select a battery suitable as a replacement.

A battery information management system according to one aspect of the present disclosure comprises: a server, a first terminal, and a second terminal. The server acquires a travel history from an electric-powered vehicle on which a replaceable battery is mounted, uses the acquired travel history to estimate a deterioration state of the battery on the electric-powered vehicle, and stores the estimated deterioration state in association with information for identifying the electric-powered vehicle. The first terminal communicates with the server, and executes, for the server, a transmission request for deterioration information indicating the deterioration state of the battery mounted on the electric-powered vehicle. The second terminal communicates with the first terminal, and stores inventory information on an inventory of a replacement battery for replacing the battery, the replacement battery being carried by a shop. When the transmission request for the deterioration information is executed at the first terminal, the server transmits the deterioration information to the first terminal. When the second terminal receives, from the first terminal, information on a replacement condition for the battery mounted on the electric-powered vehicle, the second terminal transmits, to the first terminal, the inventory information corresponding to the replacement battery that satisfies the replacement condition.

According to such a configuration, the deterioration state of the battery mounted on the electric-powered vehicle can be estimated from the travel history, and the user can acquire the deterioration state of the battery mounted on the electric-powered vehicle at the first terminal. The user can thus acquire accurate information on the deterioration state of the battery mounted on the electric-powered vehicle, thereby setting an appropriate replacement condition in accordance with the acquired deterioration state. The user can thus acquire, from the second terminal, the inventory information on replacement batteries that are suitable for replacing the battery mounted on the electric-powered vehicle. This allows the user to appropriately select a battery suitable as a replacement.

In one embodiment, the replacement condition includes at least one of: information on a degree of deterioration of the replacement battery, information on a fee for replacement with the replacement battery, and information on a manufacturer of the replacement battery.

According to such a configuration, the user can appropriately select a battery suitable as a replacement from the inventory information.

A battery information management method according to another aspect of the present disclosure is a battery information management method using a server, a first terminal that communicates with the server, and a second terminal that communicates with the first terminal. The battery information management method comprises: (i) at the server, acquiring a travel history from an electric-powered vehicle on which a replaceable battery is mounted, using the acquired travel history to estimate a deterioration state of the battery on the electric-powered vehicle, and storing the estimated deterioration state in association with information for identifying the electric-powered vehicle; (ii) at the first terminal, executing, for the server, a transmission request for deterioration information indicating the deterioration state of the battery mounted on the electric-powered vehicle; (iii) at the second terminal, storing inventory information on an inventory of a replacement battery for replacing the battery, the replacement battery being carried by a shop; (iv) when the transmission request for the deterioration information is executed at the first terminal, transmitting the deterioration information from the server to the first terminal; and (v) when the second terminal receives information on a replacement condition for the battery mounted on the electric-powered vehicle from the first terminal, transmitting, from the second terminal to the first terminal, the inventory information corresponding to the replacement battery that satisfies the replacement condition.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a block diagram showing an example configuration of a battery information management system in the present embodiment.

FIG. 2 is a diagram showing a specific example of each component of the battery information management system.

FIG. 3 is a flowchart showing an example control process executed at a server and an electric-powered vehicle.

FIG. 4 is a flowchart showing an example control process executed at the server and a user terminal.

FIG. 5 is a graph illustrating a method for calculating a capacity maintenance rate at the time when inquiry information is received.

FIG. 6 is a flowchart showing an example control process executed at a shop terminal and the user terminal.

FIG. 7 is a diagram showing an example configuration of a list of replacement batteries displayed on the display of the user terminal.

FIG. 8 is a diagram illustrating various types of information exchanged between the components of the battery information management system.

FIG. 9 is a diagram illustrating various transaction manners between the components of the battery information management system.

### DESCRIPTION OF THE PREFERRED EMBODIMENTS

An embodiment of the present disclosure will now be described in detail with reference to the drawings. In the drawings, the same or corresponding parts are denoted by the same reference signs, and the description thereof is not repeated.

<Basic Configuration of Battery Information Management System 1>

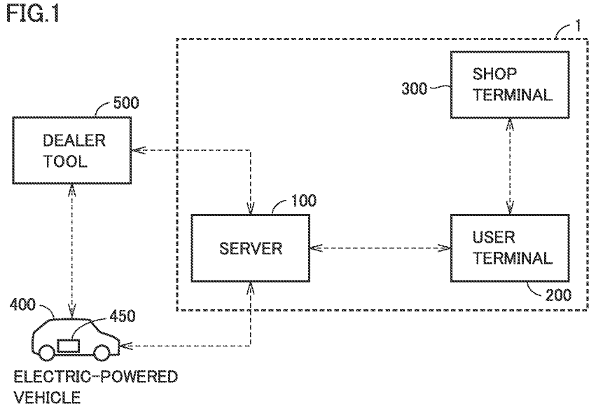

FIG. 1 is a block diagram showing an example configuration of a battery information management system 1 in the present embodiment. Battery information management system 1 includes a server 100, a user terminal 200, and a shop terminal 300.

Server 100 is configured to communicate with each of user terminal 200, an electric-powered vehicle 400, and a dealer tool 500. Server 100 is configured to receive various types of information from user terminal 200, and receive various types of information from electric-powered vehicle 400 or dealer tool 500. Further, server 100 is configured to transmit various types of information to user terminal 200, and transmit various types of information to electric-powered vehicle 400 or dealer tool 500.

Electric-powered vehicle 400 may be any vehicle having at least a driving motor generator (not shown) and a battery 450 that can supply electric power to the driving motor generator. For example, electric-powered vehicle 400 may be an electric vehicle, or may be a hybrid vehicle which is additionally equipped with an engine. Battery 450 can include various types of secondary batteries, such as lithium-ion secondary batteries or nickel-metal hydride secondary batteries.

Dealer tool 500 is a service tool configured to acquire predetermined information (e.g., travel history information) from electric-powered vehicle 400.

Dealer tool 500 is placed at, for example, a dealer that sells electric-powered vehicle 400, or a shop that carries replacement batteries as described later. Dealer tool 500 is communicably connected to electric-powered vehicle 400 using a cable or the like, thus acquiring the above-described predetermined information.

User terminal 200 is a terminal accessible to the user. User terminal 200 executes various requests directed to server 100 or shop terminal 300, and notifies the user of the information received from server 100 or shop terminal 300. For example, user terminal 200 may be a personal computer, or may be a mobile terminal, such as a smartphone. User terminal 200 is configured to receive and transmit various types of information from and to server 100 and shop terminal 300. User terminal 200 is configured to communicate with server 100 or shop terminal 300, via a predetermined network (e.g., the Internet or a private communication network). The communication between user terminal 200 and server 100, or the communication between user terminal 200 and shop terminal 300 may include at least one of wired communication and wireless communication.

Shop terminal 300 stores information on an inventory of replacement batteries in a shop (e.g., a dealer or a seller of replacement batteries) that carries new or used batteries for replacing battery 450 mounted on electric-powered vehicle 400 (hereinafter referred to as “replacement batteries”). Shop terminal 300 also receives, from user terminal 200, an expression of intention for replacing battery 450. Shop terminal 300 may be, for example, a personal computer.

<Specific Example of Each Component of Battery Information Management System 1>

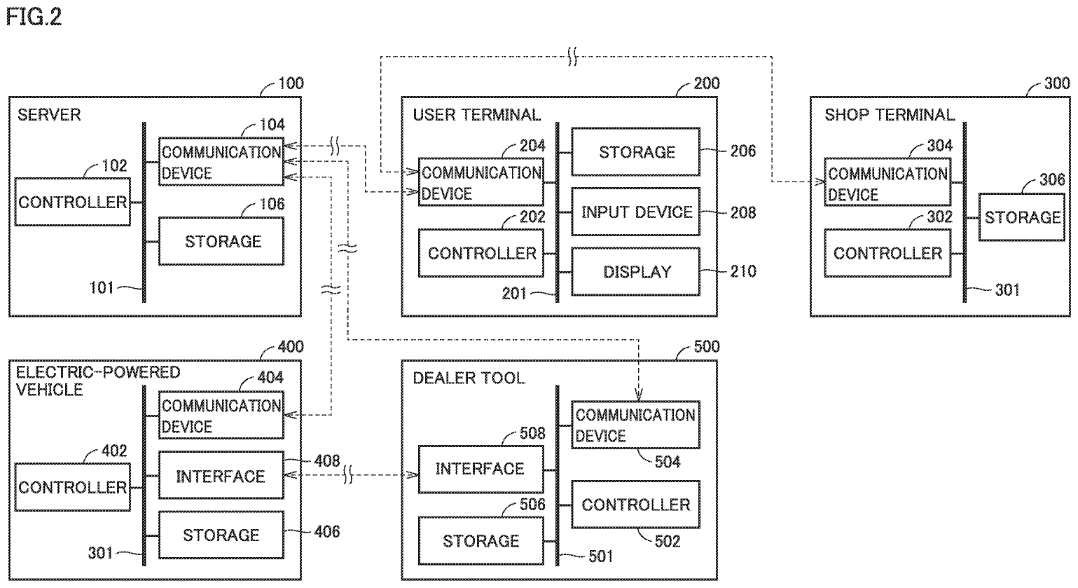

FIG. 2 is a diagram showing a specific example of each component of battery information management system 1. As shown in FIG. 2, server 100 includes, for example, a controller 102, a communication device 104, and a storage 106. The components of server 100 are communicably connected to one another through a communication bus 101.

Controller 102 includes, for example, a central processing unit (CPU). Controller 102 is configured to execute a predetermined computing process, based on various types of information (data, programs, or the like) stored in storage 106, or based on various types of information received from electric-powered vehicle 400 or user terminal 200 via communication device 104, for example.

Communication device 104 is configured to communicate with, for example, each of user terminal 200, electric-powered vehicle 400, and dealer tool 500. The communication between communication device 104 and user terminal 200, the communication between communication device 104 and electric-powered vehicle 400, and the communication between communication device 104 and dealer tool 500 are performed by at least one of wireless communication and wired communication. For example, the communication may be performed through relay stations (e.g., wireless base stations) or a predetermined network, or may be directly performed with no involvement by a relay station or predetermined network.

Example communication systems for the wireless communication include: a wireless communication system that can transmit and receive signals via relay stations or a predetermined network, using a wireless local area network (LAN) represented by IEEE802.11, or using wireless communication standards of cellular telephones (e.g., 2G, 3G, 4G, or 5G); and a wireless communication system that can directly transmit and receive signals to and from the party at the other end, for example, using wireless communication standards, such as Bluetooth (registered trademark).

Storage 106 includes, for example, a memory, such as a read only memory (ROM) and a random access memory (RAM); and a high-capacity storage device, such as a hard disk drive or a solid state drive.

User terminal 200 includes, for example, a controller 202, a communication device 204, a storage 206, an input device 208, and a display 210. The components of user terminal 200 are communicably connected through a communication bus 201.

Controller 202 includes, for example, a CPU. Controller 202 is configured to execute a predetermined computing process, based on various types of information stored in storage 206, or based on various types of information received from server 100 or shop terminal 300 via communication device 204.

Communication device 204 is configured to communicate with, for example, each of server 100 and shop terminal 300. The communication between communication device 204 and server 100, and the communication between communication device 204 and shop terminal 300 are the same as the above-described communication, and thus the detailed description thereof is not repeated.

Storage 206 includes, for example, a memory, such as a ROM and a RAM; and a high-capacity storage device, such as a hard disk drive or a solid state drive. Input device 208 is configured with, for example, a keyboard, a mouse, a touch panel, or the like. Input device 208 transmits, to controller 202, a signal corresponding to the user's operation on the keyboard, the mouse, the touch panel, or the like.

Display 210 is configured with, for example, a liquid crystal display or an organic electro luminescent (EL) display. Display 210 displays image information and text information stored in storage 206, in accordance with a control signal from controller 202.

Shop terminal 300 includes, for example, a controller 302, a communication device 304, and a storage 306. The components of shop terminal 300 are communicably connected through a communication bus 301.

Controller 302 includes, for example, a CPU. Controller 302 is configured to execute a predetermined computing process, based on various types of information stored in storage 306, or based on various types of information received from user terminal 200 via communication device 304.

Communication device 304 is configured to communicate with user terminal 200. The communication between communication device 304 and user terminal 200 is the same as the above-described communication, and thus the detailed description thereof is not repeated.

Storage 306 includes, for example, a memory, such as a ROM and a RAM; and a high-capacity storage device, such as a hard disk drive or a solid state drive. Storage 306 stores, for example, inventory information on an inventory of replacement batteries carried in a shop.

Electric-powered vehicle 400 includes, for example, a controller 402, a communication device 404, a storage 406, and an interface 408. The components of electric-powered vehicle 400 are communicably connected through a communication bus 401.

Controller 402 includes, for example, a CPU. Controller 402 is configured to execute a predetermined computing process, based on various types of information stored in storage 406, based on various types of information received from server 100 via communication device 404, or based on various types of information received from dealer tool 500 via an interface 508.

Communication device 404 is configured to communicate with, for example, server 100. The communication between communication device 404 and server 100 is performed by, for example, wireless communication. The wireless communication is as described above, and thus the detailed description thereof is not repeated.

Storage 406 includes, for example, a memory, such as a ROM and a RAM; and a high-capacity storage device, such as a hard disk drive or a solid state drive. Storage 406 stores, for example, various types of information acquired during the travel of electric-powered vehicle 400, as a travel history.

Interface 408 is, for example, directly connectable to dealer tool 500 using a cable or the like, thus enabling wired communication. Interface 408 includes, for example, a connector.

Dealer tool 500 includes a controller 502, a communication device 504, a storage 506, and an interface 508. The components of dealer tool 500 are communicably connected through a communication bus 501.

Controller 502 includes, for example, a CPU. Controller 502 is configured to execute a predetermined computing process, based on various types of information stored in storage 506, based on various types of information received from server 100 via communication device 504, or based on various types of information received from electric-powered vehicle 400 via an interface 508.

Communication device 504 is configured to communicate with, for example, server 100. The communication between communication device 504 and server 100 is the same as the above-described communication, and thus the detailed description thereof is not repeated.

Storage 506 includes, for example, a memory, such as a ROM and a RAM; and a high-capacity storage device, such as a hard disk drive or a solid state drive. Storage 506 stores, for example, a travel history of electric-powered vehicle 400 received via interface 508.

Interface 508 is, for example, directly connectable to electric-powered vehicle 400 using a cable or the like, thus enabling wired communication. Interface 508 includes, for example, a connector connectable to interface 408.

<Battery Replacement Service>

The following describes an example service for replacing a battery mounted on the user's electric-powered vehicle 400 with a replacement battery.

For example, a user who uses electric-powered vehicle 400 gives an expression of intention to replace a battery (hereinafter referred to as “replacement intention expression”) to a shop that carries replacement batteries. The user also notifies, to the shop, a desired condition for a replacement battery (hereinafter referred to as a “replacement condition”). The replacement condition includes, for example, information on the degree of deterioration of a replacement battery.

For example, when the shop receives a replacement intention expression and a replacement condition from the user, then the shop presents a plurality of replacement batteries that satisfy the replacement condition, from the inventory of replacement batteries carried in the shop. The user selects one of the plurality of replacement batteries and performs a payment process, for example. Then, the user can receive a service to replace the battery mounted on electric-powered vehicle 400 with the selected replacement battery at a predetermined service garage.

Such a battery replacement service provided to the user from the shop can be implemented using user terminal 200 and shop terminal 300.

For example, when user terminal 200 receives a signal indicating that input device 208 has received a user operation of inputting a replacement intention expression and a replacement condition, then user terminal 200 transmits information indicating the replacement intention expression and the replacement condition, to shop terminal 300.

Upon receiving this information, shop terminal 300 extracts information on the replacement batteries that satisfy the replacement condition, from the information on replacement batteries stored in storage 306. Shop terminal 300 then transmits the extracted information on one or more replacement batteries to user terminal 200.

User terminal 200 displays, on display 210, the received information on one or more replacement batteries. When input device 208 receives an operation of selecting any one of the received one or more replacement batteries as a replacement, user terminal 200 transmits information for identifying the selected replacement battery to shop terminal 300.

Based on the information received from user terminal 200, shop terminal 300 identifies the selected replacement battery, sets the identified battery as a replacement for battery 450 mounted on the user's electric-powered vehicle 400, and performs a payment process, for example.

When battery 450 mounted on electric-powered vehicle 400 is deteriorated, the user can use the battery replacement service as described above to replace battery 450 mounted on electric-powered vehicle 400 with a replacement battery, thus prolonging the potential travel distance that has been reduced due to the deterioration.

However, even with the same duration of use, the deterioration state of a battery of an electric-powered vehicle can greatly vary depending on the use history of the electric-powered vehicle. Thus, in some cases, the deterioration state of a battery cannot be accurately estimated from battery information, such as the number of times the battery can be charged, the number of days the battery was used, the usable period of time, or the state of charge (SOC) indicating the quantity of remaining electricity.

If the user cannot accurately know the deterioration state of the battery mounted on his vehicle, at the time of receiving the above-described battery replacement service, he may select a replacement battery that is more deteriorated than before the replacement.

To address this, in the present embodiment, each component of battery information management system 1 operates as follows. Server 100 acquires a travel history from electric-powered vehicle 400 on which a replaceable battery is mounted, uses the acquired travel history to estimate the deterioration state of the battery on electric-powered vehicle 400, and stores the estimated deterioration state in association with information for identifying electric-powered vehicle 400.

User terminal 200 executes, for server 100, a transmission request for the battery deterioration information indicating the deterioration state of the battery mounted on electric-powered vehicle 400.

When the transmission request for the battery deterioration information is executed at user terminal 200, server 100 transmits the battery deterioration information of the battery mounted on electric-powered vehicle 400 to user terminal 200.

Shop terminal 300 stores inventory information on an inventory of replacement batteries carried by a shop. For example, the inventory information includes: information for identifying replacement batteries carried by the shop; the battery deterioration information of the replacement batteries; and the replacement fees of the replacement batteries, these information items being associated with one another.

When shop terminal 300 receives, from user terminal 200, information on a replacement condition for the battery mounted on electric-powered vehicle 400, then shop terminal 300 transmits, to user terminal 200, the inventory information corresponding to the replacement batteries that satisfy the replacement condition.

With such a configuration, the deterioration state of battery 450 mounted on electric-powered vehicle 400 can be estimated from a travel history of electric-powered vehicle 400, and the user can acquire the deterioration state of battery 450 at user terminal 200. The user can thus acquire accurate information on the deterioration state of battery 450, thereby setting an appropriate replacement condition in accordance with the acquired deterioration state. The user can thus acquire, from shop terminal 300, the inventory information on replacement batteries that are suitable for replacing battery 450. This allows the user to appropriately select a battery suitable as a replacement.

<Control Process Executed at Server 100 and Electric-Powered Vehicle 400>

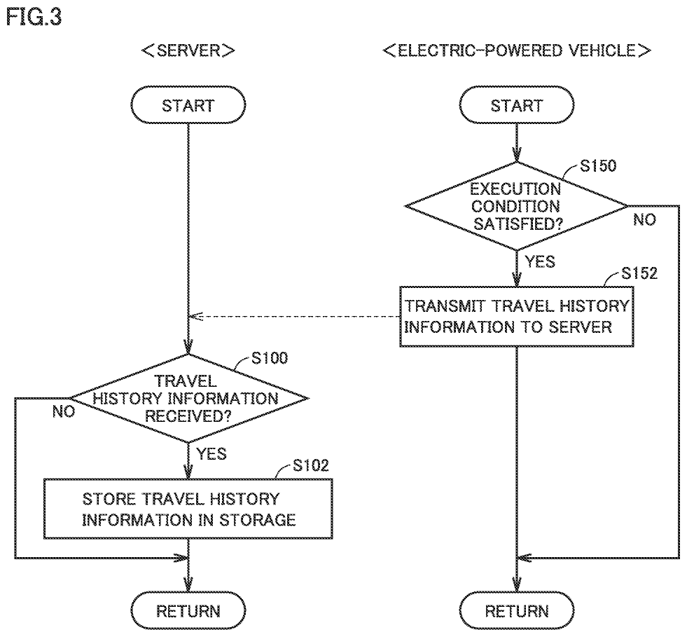

With reference to FIG. 3, a control process executed at server 100 (more specifically, controller 102) and electric-powered vehicle 400 (more specifically, controller 402) will now be described. FIG. 3 is a flowchart showing an example control process executed at server 100 and electric-powered vehicle 400.

As shown in the flowchart on the left side of FIG. 3, at step 100 (hereinafter, the step is abbreviated to “S”), server 100 determines whether or not travel history information has been received from electric-powered vehicle 400. The travel history information includes: information indicating a travel history of electric-powered vehicle 400, and information for identifying electric-powered vehicle 400 (e.g., a vehicle ID). For example, the travel history includes: the total travel distance with electric power, the duration of a high-load operation state at the time of EV travel (hereinafter referred to as “total high-load operation time”); the cumulative total value of charging current (hereinafter also referred to as “the total amount of charge”); the cumulative total value of discharging current (hereinafter also referred to as “the total amount of discharge”); the history of change in battery temperature; the history of change in current; and the history of change in SOC. The high-load operation state includes, for example, the state in which the accelerator position of electric-powered vehicle 400 is equal to or greater than a threshold value, the state in which the driving force required for electric-powered vehicle 400 (“required driving force”) is equal to or greater than a threshold value, or the state in which the power required for electric-powered vehicle 400 (“required power”) is equal to or greater than a threshold value. The travel history is not limited to the above-listed histories. For example, the travel history may include at least any one of the above-listed histories, or may include a history other than the above. When it is determined that travel history information has been received from electric-powered vehicle 400 (YES at S100), the process proceeds to S102.

At S102, server 100 stores the travel history information in storage 106.

Specifically, server 100 stores, in a predetermined storage area of storage 106, a vehicle ID and travel history included in the travel history information, by associating them with each other. When server 100 determines that travel history information has not been received (NO at S100), the process ends.

On the other hand, as shown in the flowchart on the right side of FIG. 3, at S150, electric-powered vehicle 400 determines whether or not an execution condition is satisfied. The execution condition is a condition for executing the transmission of the travel history information to server 100. For example, the execution condition may include the condition that a predetermined period of time has elapsed after the previous transmission, or may include the condition that any of the information items representing the travel history has changed by a threshold value or greater from the previous transmission. When server 100 determines that the execution condition is satisfied (YES at S150), the process proceeds to S152.

At S152, electric-powered vehicle 400 transmits, to server 100, travel history information including a vehicle ID and a travel history. When electric-powered vehicle 400 determines that the execution condition is not satisfied (NO at S150), the process ends.

<Control Process Executed at Server 100 and User Terminal 200>

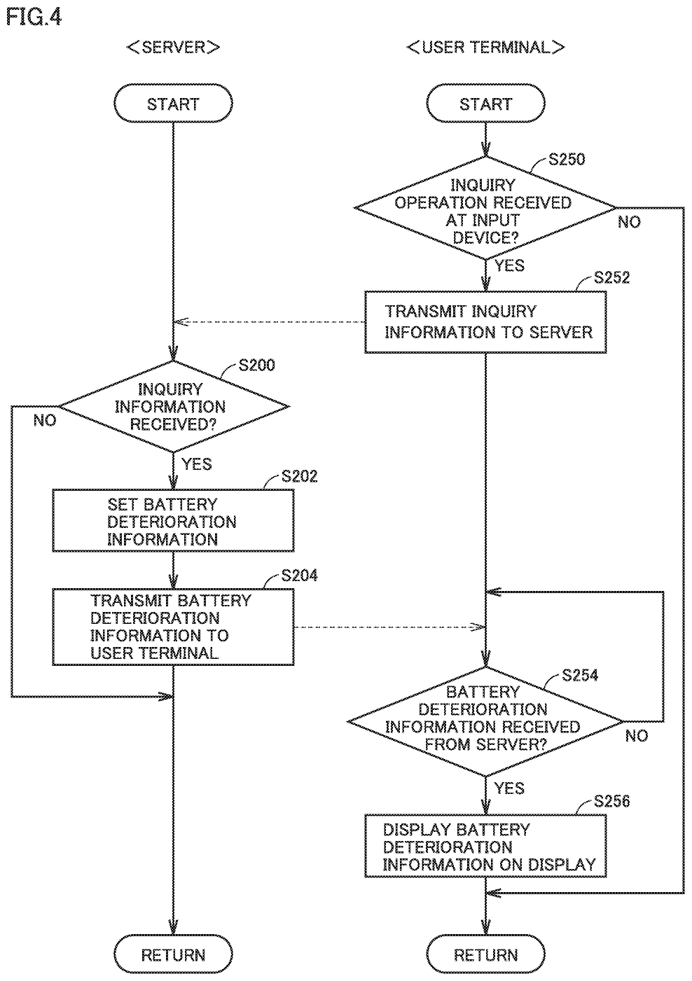

With reference to FIG. 4, a control process executed at server 100 (more specifically, controller 102) and user terminal 200 (more specifically, controller 202) will now be described. FIG. 4 is a flowchart showing an example control process executed at server 100 and user terminal 200.

As shown in the flowchart on the left side of FIG. 4, at S200, server 100 determines whether or not information on inquiry about the deterioration state of the battery (hereinafter referred to as “inquiry information”) has been received. The inquiry information includes: a vehicle ID; information indicating a transmission request for information on the battery deterioration state (hereinafter referred to as “battery deterioration information”); and information for identifying the user from which the inquiry was sent. The battery deterioration information indicates a degree of deterioration of the battery, which includes a capacity maintenance rate in the present embodiment. The information for identifying the user from which the inquiry was sent includes, for example, a user ID registered beforehand by the user and stored in storage 106 of server 100. When server 100 determines that inquiry information has been received (YES at S200), the process proceeds to S202.

At S202, server 100 sets battery deterioration information. For example, server 100 corrects a deterioration reference curve using the above-described travel history. The deterioration reference curve is a curve that shows a temporal change of the capacity maintenance rate relative to the default value, the deterioration reference curve being predetermined in accordance with the specification of battery 450 of electric-powered vehicle 400. For example, server 100 may correct the deterioration reference curve by calculating a correction factor for the deterioration reference curve using, for example, the above-described travel history and a map.

The map is adjusted by, for example, experiment. For example, the map is set as follows: for a period starting when the capacity maintenance rate is at the default value, a lower correction factor value is applied as at least one of the plurality of values included in the travel history becomes higher than a reference value.

Server 100 calculates, from the corrected deterioration curve, a capacity maintenance rate at the time when the inquiry information is received. Server 100 then sets the calculated value of capacity maintenance rate, as battery deterioration information.

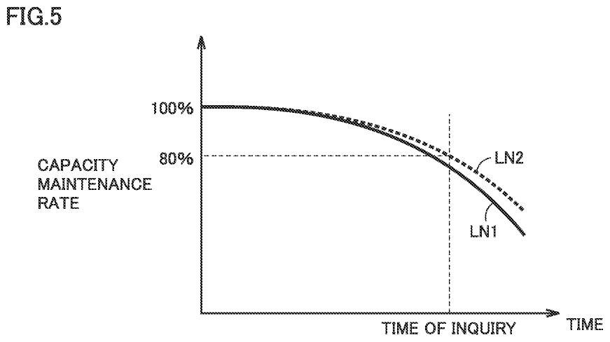

FIG. 5 is a graph illustrating a method for calculating a capacity maintenance rate at the time when inquiry information is received. The vertical axis in FIG. 5 indicates the capacity maintenance rate. The horizontal axis in FIG. 5 indicates the cumulative total period of use. LN1 (solid line) in FIG. 5 indicates a deterioration reference curve. LN2 (broken line) in FIG. 5 indicates a corrected deterioration curve.

Server 100 corrects the deterioration reference curve indicated by LN1 of FIG. 5 using the travel history, and sets the corrected deterioration curve indicated by LN2 of FIG. 5. In the corrected deterioration curve, server 100 calculates a capacity maintenance rate at the time of inquiry (e.g., 80%). Server 100 sets the calculated capacity maintenance rate, as battery deterioration information.

At S204, server 100 transmits the set battery deterioration information to user terminal 200 from which the inquiry was sent. When server 100 determines that inquiry information has not been received (NO at S200), the process ends.

As shown in the flowchart on the right side of FIG. 4, at S250, user terminal 200 determines whether or not input device 208 has received an inquiry operation. For example, when input device 208 receives an operation of inputting a vehicle ID and an operation of requesting the battery deterioration information on battery 450, user terminal 200 determines that input device 208 has received an inquiry operation.

When user terminal 200 determines that input device 208 has received an inquiry operation (YES at S250), the process proceeds to S252.

At S252, user terminal 200 transmits inquiry information to server 100. The inquiry information is as described above, and thus the detailed description thereof is not repeated.

At S254, user terminal 200 determines whether or not battery deterioration information has been received from server 100. For example, when battery deterioration information is included in the information received from server 100, user terminal 200 determines that battery deterioration information has been received from server 100. When user terminal 200 determines that battery deterioration information has been received from server 100 (YES at S254), the process proceeds to S256.

At S256, user terminal 200 displays the battery deterioration information on display 210. When user terminal 200 determines that input device 208 has not received an inquiry operation (NO at S250), the process ends. When user terminal 200 determines that battery deterioration information has not been received from server 100 (NO at S254), the process returns to S254.

<Control Process Executed at Shop Terminal 300 and User Terminal 200>

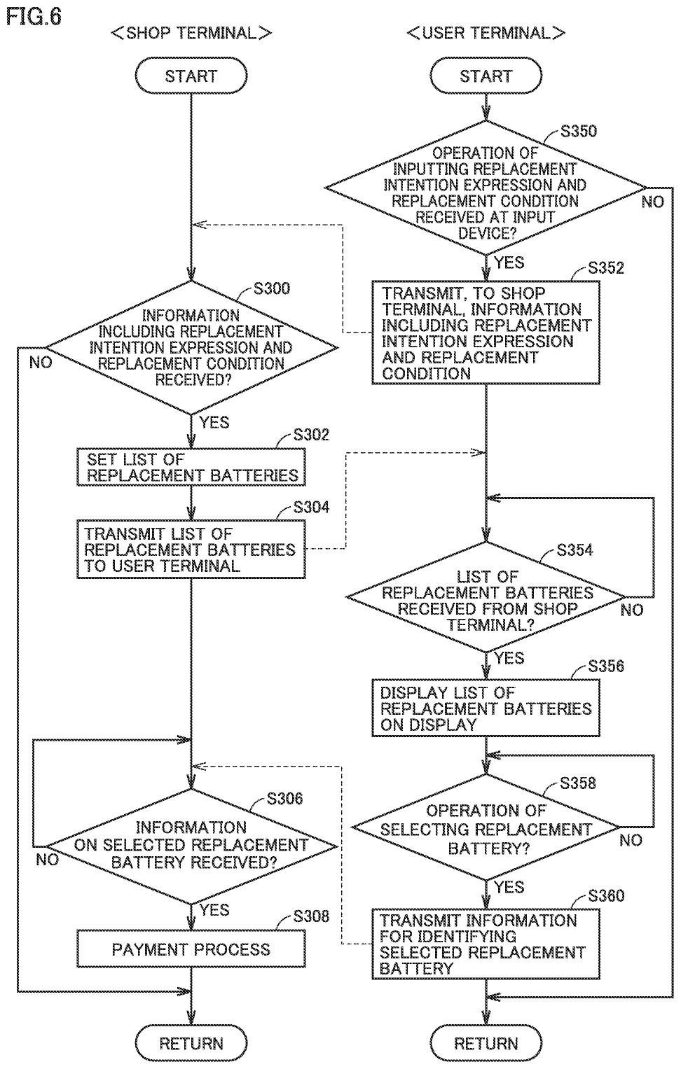

With reference to FIG. 6, a control process executed at shop terminal 300 (more specifically, controller 302) and user terminal 200 (more specifically, controller 202) will now be described. FIG. 6 is a flowchart showing an example control process executed at shop terminal 300 and user terminal 200.

As shown in the flowchart on the left side of FIG. 6, at S300, shop terminal 300 determines whether or not information including a replacement intention expression and a replacement condition has been received. When shop terminal 300 determines that information including a replacement intention expression and a replacement condition has been received (YES at S300), the process proceeds to S302.

At S302, shop terminal 300 sets a list of replacement batteries. Specifically, shop terminal 300 extracts information on a plurality of replacement batteries that satisfy the replacement condition, from the information on the replacement batteries carried in the shop. Shop terminal 300 then sets the extracted information on the plurality of replacement batteries, as a list of replacement batteries. The replacement condition includes, for example, a condition for the capacity maintenance rate which the user desires for a replacement battery. Specifically, the replacement condition includes, for example, the condition that the capacity maintenance rate is higher than a threshold value. Shop terminal 300 extracts information on the replacement batteries that are higher than a threshold value in capacity maintenance rate, from the information on the replacement batteries carried in the shop. Shop terminal 300 then sets the extracted information as a list of replacement batteries. For example, the list of replacement batteries includes: information for identifying batteries, information on the capacity maintenance rate, and information on the replacement fee.

At S304, shop terminal 300 transmits the set list of replacement batteries to user terminal 200.

At S306, shop terminal 300 determines whether or not information for identifying a selected replacement battery has been received from user terminal 200.

For example, when the information received from user terminal 200 matches information for identifying any battery included in the list of replacement batteries, shop terminal 300 determines that information for identifying a selected replacement battery has been received from user terminal 200. When shop terminal 300 determines that information for identifying a selected replacement battery has been received from user terminal 200 (YES at S306), the process proceeds to S308.

At S308, shop terminal 300 executes a payment process. For example, when an automatic payment is selected, where credit card information etc. registered beforehand by the user is to be used, shop terminal 300 executes a payment process for the replacement fee for the selected replacement battery.

As shown in the flowchart on the right side of FIG. 6, at S350, user terminal 200 determines whether or not input device 208 has received an operation of inputting a replacement intention expression and a replacement condition. The operation of inputting a replacement intention expression may be, for example, an operation of selecting a predetermined image displayed on the display screen for expressing a replacement intention (e.g., a click of a mouse, or a touch on a touch panel). When user terminal 200 determines that input device 208 has received an operation of inputting a replacement intention expression and a replacement condition (YES at S350), the process proceeds to S352.

At S352, user terminal 200 transmits, to shop terminal 300, information including a replacement intention expression and a replacement condition. The information including a replacement intention expression and a replacement condition further includes information for identifying the user from which the replacement intention expression was transmitted. The information for identifying the user includes, for example, a user ID registered beforehand and stored in storage 306 of shop terminal 300. The user ID stored in storage 106 of server 100 and the user ID stored in storage 306 of shop termina 1300 may be the same user ID shared between server 100 and shop terminal 300.

At S354, user terminal 200 determines whether or not a list of replacement batteries has been received from shop terminal 300. When user terminal 200 determines that a list of replacement batteries has been received from shop terminal 300 (YES at S354), the process proceeds to S356.

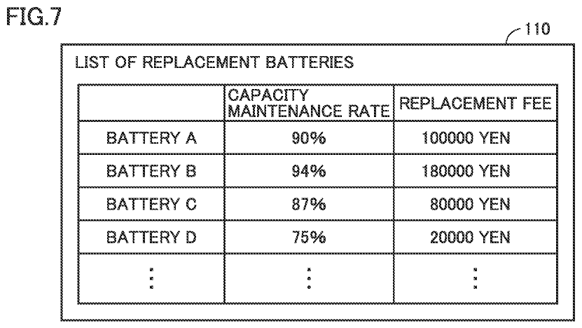

At S356, user terminal 200 displays the list of replacement batteries on display 210. FIG. 7 is a diagram showing an example configuration of a list of replacement batteries displayed on display 210 of user terminal 200. The display screen of display 210 displays, as a tabular list of replacement batteries, information for identifying each of a plurality of replacement batteries (e.g., batteries A to D); the capacity maintenance rate corresponding to each of the plurality of replacement batteries; and the replacement fee corresponding to each of the plurality of replacement batteries.

The list of replacement batteries shown in FIG. 7 shows that: battery A has a capacity maintenance rate of 90%, with a replacement fee of 100,000 yen; battery B has a capacity maintenance rate of 94%, with a replacement fee of 180,000 yen; battery C has a capacity maintenance rate of 87%, with a replacement fee of 80,000 yen; and battery D has a capacity maintenance rate of 75%, with a replacement fee of 20,000 yen.

The number of replacement batteries displayed as the list of replacement batteries is not limited to four, but may be three or less, or five or more, for example.

At S358, user terminal 200 determines whether or not an operation of selecting a replacement battery has been made. For example, when input device 208 has received an operation of selecting any of a plurality of replacement batteries displayed on the list of replacement batteries on display 210, user terminal 200 determines that an operation of selecting a replacement battery has been made. When user terminal 200 determines that an operation of selecting a replacement battery has been made (YES at S358), the process proceeds to S360.

At S360, user terminal 200 transmits information for identifying the selected replacement battery. When user terminal 200 determines that input device 208 has not received an operation of inputting a replacement intention expression and a replacement condition (NO at S350), the process ends. When user terminal 200 determines that a list of replacement batteries has not been received from shop terminal 300 (NO at S354), the process returns to S354. Further, when user terminal 200 determines that an operation of selecting a replacement battery has not been made (NO at S358), the process ends.

<Operation of Components of Battery Information Management System>

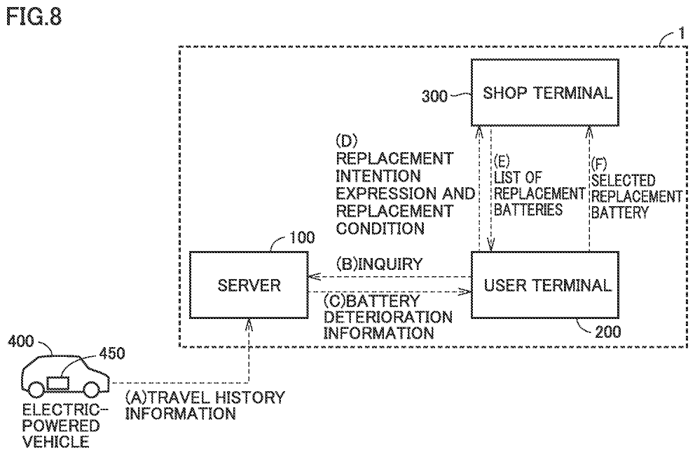

With reference to FIG. 8, the following describes the operation of each component of battery information management system 1 in the present embodiment based on the above-described configuration and the flowcharts. FIG. 8 is a diagram illustrating various types of information exchanged between the components of battery information management system 1.

As indicated by FIG. 8(A), each time the execution condition is satisfied by, for example, a lapse of a predetermined period of time (YES at S150), electric-powered vehicle 400 transmits travel history information including a vehicle ID and a travel history to server 100 (S152).

When server 100 receives the travel history information (YES at S100), server 100 stores the travel history corresponding to the received vehicle ID in a predetermined storage area of storage 106 (S102).

When the user operates input device 208 of user terminal 200 to inquire for the battery deterioration information on battery 450 mounted on electric-powered vehicle 400 (YES at S250), user terminal 200 transmits the inquiry information to server 100, as indicated by FIG. 8(B) (S252).

When server 100 determines that the inquiry information has been received (YES at S200), server 100 acquires a travel history from storage 106 based on the vehicle ID included in the inquiry information, and sets battery deterioration information (S202). Then, as indicated by FIG. 8(C), server 100 transmits the set battery deterioration information to user terminal 200 from which the inquiry was sent (S204).

When user terminal 200 determines that the battery deterioration information has been received from server 100 (YES at S254), user terminal 200 displays the battery deterioration information on display 210 (S256).

For example, when the user wants to express a desire for replacing battery 450 mounted on electric-powered vehicle 400 to a shop that carries replacement batteries, the user operates input device 208 of user terminal 200 to input a replacement intention expression and a replacement condition. When user terminal 200 determines that input device 208 has received an operation of inputting a replacement intention expression and a replacement condition (YES at S350), user terminal 200 transmits, to shop terminal 300, information including the replacement intention expression and the replacement condition, as indicated by FIG. 8(D) (S352).

When shop terminal 300 determines that the information including the replacement intention expression and the replacement condition has been received from user terminal 200 (YES at S300), then shop terminal 300 sets a list of replacement batteries (S302), and transmits the set list of replacement batteries to user terminal 200, as indicated by FIG. 8(E) (S304).

When user terminal 200 determines that the list of replacement batteries has been received from shop terminal 300 (YES at S354), user terminal 200 displays, on display 210 of user terminal 200, information on the plurality of replacement batteries included in the list of replacement batteries (S356).

When user terminal 200 determines that the user has made an operation of selecting any one of the plurality of replacement batteries displayed on display 210 (YES at S358), user terminal 200 transmits information for identifying the selected replacement battery to shop terminal 300, as indicated by FIG. 8(F) (S360).

When shop terminal 300 determines that the information on the selected replacement battery has been received (YES at S306), shop terminal 300 executes a payment process (S308). After that, for example, at a shop or a location where a battery replacement service is provided (e.g., a service garage), battery 450 mounted on electric-powered vehicle 400 is replaced with the replacement battery selected by the user.

<Advantageous Effects of Battery Information Management System 1>

As described above, according to battery information management system 1 in the present embodiment, the deterioration state of battery 450 mounted on electric-powered vehicle 400 can be estimated from the travel history, and the user can acquire the deterioration state of battery 450 mounted on electric-powered vehicle 400 at user terminal 200. The user can thus acquire accurate information on the deterioration state of battery 450 mounted on electric-powered vehicle 400, thereby setting an appropriate replacement condition in accordance with the acquired deterioration state. The user can thus acquire, from shop terminal 300, the inventory information on replacement batteries that are suitable for replacing battery 450 mounted on electric-powered vehicle 400. This allows the user to appropriately select a battery suitable as a replacement. Thus, provided are a battery information management system and a battery information management method that allow the user to appropriately select a battery suitable as a replacement.

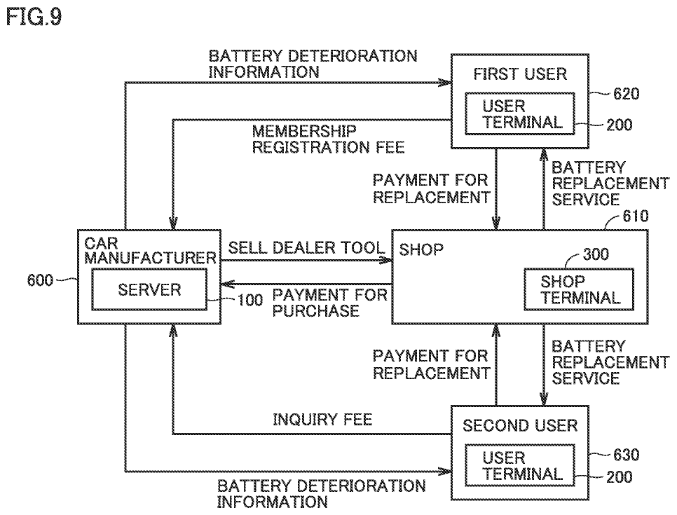

Further, in battery information management system 1 as described above, the components can conduct mutual transactions in the manners as shown in FIG. 9. FIG. 9 is a diagram illustrating various transaction manners between the components of battery information management system 1.

In an example scenario, a car manufacturer 600 manages server 100, and a first user 620 owns electric-powered vehicle 400 manufactured by car manufacturer 600.

In this case, first user 620 and car manufacturer 600 can conduct a transaction such that: first user 620 can receive battery deterioration information from car manufacturer 600, in exchange for a payment of membership fee every predetermined period of time (e.g., one year), or in exchange for a first-time payment of membership registration fee, for example. In this case, first user 620 can inquire for battery deterioration information any number of times without limitation.

Further, first user 620 and a shop 610 can conduct a transaction such that: first user 620 can receive a service for replacing battery 450 mounted on electric-powered vehicle 400 at shop 610, in exchange for a payment of the replacement fee of a replacement battery selected by the user, for example.

The transaction manner between the user and the car manufacturer is not limited to the one between first user 620 and car manufacturer 600 as described above. For example, the following transaction manner is also possible.

In an example scenario, car manufacturer 600 manages server 100, and a second user 630 owns electric-powered vehicle 400 manufactured by car manufacturer 600.

In this case, second user 630 and car manufacturer 600 can conduct a transaction such that: second user 630 can receive battery deterioration information from car manufacturer 600, in exchange for a payment of inquiry fee, for example. In this case, second user 630 can receive battery deterioration information one time for each payment of the inquiry fee.

If car manufacturer 600 manufactures dealer tool 500 and also serves as a seller that sells the manufactured dealer tool 500, the transaction may be conducted such that: car manufacturer 600 sells dealer tool 500 to shop 610, while shop 610 pays for purchase to car manufacturer 600.

<Variations>

In the above-described embodiment, the replacement condition includes the condition that the capacity maintenance rate is higher than a threshold value, as an example. The replacement condition, however, is not limited to such a condition. For example, the replacement condition may include: a condition that defines a range of replacement fees (e.g., equal to or less than a threshold value); or a condition that restricts the manufacturer; or a condition that defines a range of potential travel distances (e.g., equal to or greater than a threshold value), instead of the capacity maintenance rate.

Further, in the above-described embodiment, server 100 receives travel history information directly from electric-powered vehicle 400 through communication. Instead, server 100 may receive travel history information from electric-powered vehicle 400 via dealer tool 500.

For example, dealer tool 500 is configured to acquire travel history information from electric-powered vehicle 400 via interface 508. A specific configuration is as described above, and thus the detailed description thereof is not repeated.

If dealer tool 500 is connected to electric-powered vehicle 400, dealer tool 500 requests travel history information to electric-powered vehicle 400. In response to the request from dealer tool 500, electric-powered vehicle 400 transmits travel history information to dealer tool 500 via interface 508 and interface 408. Dealer tool 500 stores the received travel history information in storage 506, and transmits the travel history to server 100 via communication device 504.

With such a configuration, server 100 can also acquire a travel history of electric-powered vehicle 400.

Further, in the above-described embodiment, server 100 stores the travel history of one electric-powered vehicle 400, and the battery deterioration information on battery 450 mounted on electric-powered vehicle 400. Instead, server 100 may store the travel histories of a plurality of electric-powered vehicles, and the battery deterioration information on the batteries mounted on the plurality of respective electric-powered vehicles. In this case, when receiving an inquiry from a user, server 100 may transmit, to the user, the battery deterioration information on an electric-powered vehicle specified by the user at the time of the inquiry.

Further, in the above-described embodiment, the deterioration reference curve of capacity maintenance rate is corrected, and a capacity maintenance rate at the time of inquiry is calculated in the corrected deterioration curve. Instead, for example, a full charge capacity at the time of inquiry may be calculated from the travel history, and, based on the ratio between the full charge capacity and the default value, a capacity maintenance rate at the time of inquiry may be calculated.

Further, in the above-described embodiment, the user uses user terminal 200 both when inquiring of server 100 for the battery deterioration information, and when giving a replacement intention expression to shop terminal 300. However, using the same device for both of them is not essential. For example, the user may use a personal computer, as user terminal 200, to inquire of server 100 for the battery deterioration information. After the battery deterioration information is displayed, the user may then use a smartphone, as user terminal 200, to give a replacement intention expression to shop terminal 300.

Further, in the above-described embodiment, the battery mounted on the user's electric-powered vehicle is replaced with a replacement battery selected by the user from among a plurality of replacement batteries. Instead, shop terminal 300 may receive the battery deterioration information on the batteries carried in the shop, from server 100. In this case, the detailed deterioration states of the batteries carried in the shop can be acquired at shop terminal 300.

The above-described variations may be combined as appropriate in whole or in part.

While embodiments of the present disclosure have been described, it should be understood that the embodiments disclosed herein are by way of example in every respect, not by way of limitation. The scope of the present disclosure is defined by the terms of the appended claims, and is intended to include any modification within the scope and meaning equivalent to the terms of the claims.

What is claimed is:

1. A battery information management system comprising:
a server that acquires a travel history from an electric-powered vehicle on which a replaceable battery is mounted, uses the acquired travel history to estimate a deterioration state of the battery on the electric-powered vehicle, and stores the estimated deterioration state in association with information for identifying the electric-powered vehicle;
a first terminal that communicates with the server, and executes, for the server, a transmission request for deterioration information indicating the deterioration state of the battery mounted on the electric-powered vehicle;
a second terminal that communicates with the first terminal, and stores inventory information on an inventory of a replacement battery for replacing the battery, the replacement battery being carried by a shop, wherein
when the transmission request for the deterioration information is executed at the first terminal, the server transmits the deterioration information to the first terminal, and
when the second terminal receives, from the first terminal, information on a replacement condition for the battery mounted on the electric-powered vehicle, the second terminal transmits, to the first terminal, the inventory information corresponding to the replacement battery that satisfies the replacement condition.

2. The battery information management system according to claim 1, wherein the replacement condition includes at least one of:
information on a degree of deterioration of the replacement battery,
information on a fee for replacement with the replacement battery, and
information on a manufacturer of the replacement battery.

3. A battery information management method using a server, a first terminal that communicates with the server, and a second terminal that communicates with the first terminal, the battery information management method comprising:
at the server, acquiring a travel history from an electric-powered vehicle on which a replaceable battery is mounted, using the acquired travel history to estimate a deterioration state of the battery on the electric-powered vehicle, and storing the estimated deterioration state in association with information for identifying the electric-powered vehicle;
at the first terminal, executing, for the server, a transmission request for deterioration information indicating the deterioration state of the battery mounted on the electric-powered vehicle;
at the second terminal, storing inventory information on an inventory of a replacement battery for replacing the battery, the replacement battery being carried by a shop;
when the transmission request for the deterioration information is executed at the first terminal, transmitting the deterioration information from the server to the first terminal; and
when the second terminal receives information on a replacement condition for the battery mounted on the electric-powered vehicle from the first terminal, transmitting, from the second terminal to the first terminal, the inventory information corresponding to the replacement battery that satisfies the replacement condition.
